(19) United States
(12) Patent Application Publication
(10) Pub. No.: US 2003/0148799 A1
(43) Pub. Date: Aug. 7, 2003

(54) Electricity saving device for a user interface terminal device of cellular phone

(75) Inventor: James Chen, Hsinchu (TW)

Correspondence Address: BACON & THOMAS, PLLC, 625 SLATERS LANE, FOURTH FLOOR, ALEXANDRIA, VA, 22314

(73) Assignee: GVC Corporation, Taoyuan Hsien (TW)

(21) Appl. No.: 10/115,031

(22) Filed: Apr. 4, 2002

(30) Foreign Application Priority Data
Feb. 6, 2002 (TW) 091201423

(51) Int. Cl. H04M 1/00

(52) U.S. Cl. 455/574; 455/41; 455/550

(57) ABSTRACT

An electricity saving device for a user interface terminal device of a cellular phone is used for a cellular phone. The cellular phone includes two devices, one of them is a net communicator, and the other is a user interface terminal device. The net communicator consists of a base frequency module, radio frequency module and bluetooth module, which are responsible for building a communication with a cellular telephone base station. And, the user interface terminal device consists a bluetooth, display, keyboard, horn and microphone, which are responsible for outputting voice, displaying message, accepting keyboard input, and voice input, respectively. The keyboard is a retractable keyboard; the pressing-back action of a keyboard will activate a contact switch. A voltage signal is generated and sent into a central processing unit of the user interface terminal device after the contact switch is activated, the central processing unit command a bluetooth module of the user interface terminal device to enter into a park mode so as to save electricity.

### TECHNICAL FIELD

The present invention relates to an electricity saving device for a user interface terminal device of a cellular phone, and more particularly to an electricity saving device for a user interface terminal device by pressing a retractable keyboard of a cellular phone back to touch a switch.

### BACKGROUND OF THE INVENTION

An attestation procedure for a cellular phone is very complicated and time-consuming. The attestation procedure must be redone once a printed circuit board (PCB) is altered. The designs of a base frequency module and radio frequency module can be fixed if user interface terminal device of the cellular phone is formed to be a single unit so that every kind of shape of the user interface terminal device can be designed according to a market's need. Thus, the time for the attestation can be shortened and an attestation fee can be reduced. But, compactness must be held for the user interface terminal device if it wants to cater to the market's need, so that an electricity saving technology is needed to reduce the volume of a battery and further reduce the volume of the user interface terminal device.

### SUMMARY OF THE INVENTION

The main object of the invention is to provide an electricity saving device for a user interface terminal device of a cellular phone, enabling a user interface terminal device with a retractable keyboard to acquire the purpose of electricity saving by pressing the keyboard back to cause a bluetooth module to enter into a park mode.

Another object of the invention is to provide an electricity saving device for a user interface terminal device of a cellular phone, enabling to reduce the volume of a battery through an electricity saving technology and further to reduce the volume of the user interface terminal device.

Accordingly, the present invention provides an electricity saving device for a cellular phone. The cellular phone comprises two devices, one of the two devices is a net communicator consisting of a base frequency module, radio frequency module and bluetooth module, which are responsible for building a communication between the cellular phone and a base station. The other device comprises a user interface terminal device consisting of a bluetooth module, a display, a keyboard, speaker, and a microphone. Said terminal device is responsible for outputting voices, displaying messages, accepting a user's key-in input and voice input. The above devices are maintained a communication by means of the bluetooth modules.

A retractable keyboard is installed in the user interface terminal device. Pressing the keyboard back touches a contact installed on the device. A voltage signal is generated and sent into a CPU of the user interface terminal device after the contact switch is touched. The CPU then commands the bluetooth module of the user interface terminal device to enter into a park mode to save electricity consumption.

When the user interface terminal device is in the parking mode, if a user draws the keyboard out, another voltage signal is yielded and input into the CPU of the user interface terminal device at an instant that the keyboard leaves the contact switch. And then, the CPU commands the bluetooth module back to a normal mode.

The net communicator asks the bluetooth module of the user interface terminal device back to the normal mode when the cellular phone receives a user's message (such as a phone call or SMS), and causes the user interface terminal device to warn the user (such as ringing bell or displaying messages).

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is a block diagram of a preferred embodiment according to the present invention, showing a circuit of a net communicator of a cellular phone;

FIG. 2 is a block diagram of a preferred embodiment according to the present invention, showing a circuit of a user interface terminal device of a cellular phone;

FIG. 3 is a frontal schematic view of a preferred embodiment according to the present invention, showing a drawing-out state for a user interface terminal device;

FIG. 4 is a frontal schematic view of a preferred embodiment according to the present invention, showing a pressing-back state for a user interface terminal device; and

FIG. 5 is a flow chart of a preferred embodiment of the present invention, illustrating an operation for entering a bluetooth module of a user interface terminal device into a parking mode.

### DETAILED DESCRIPTION OF THE PREFERRED EMBODIMENTS

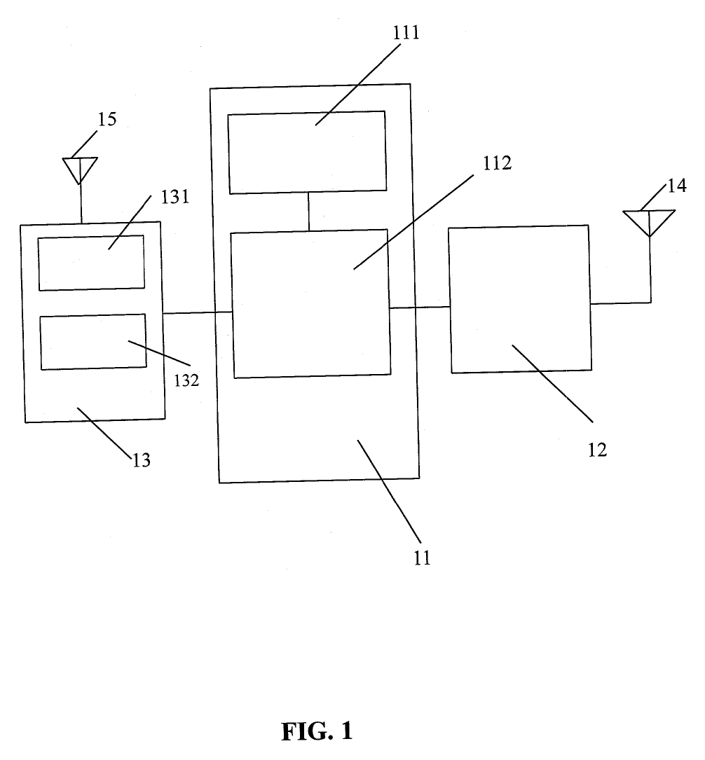

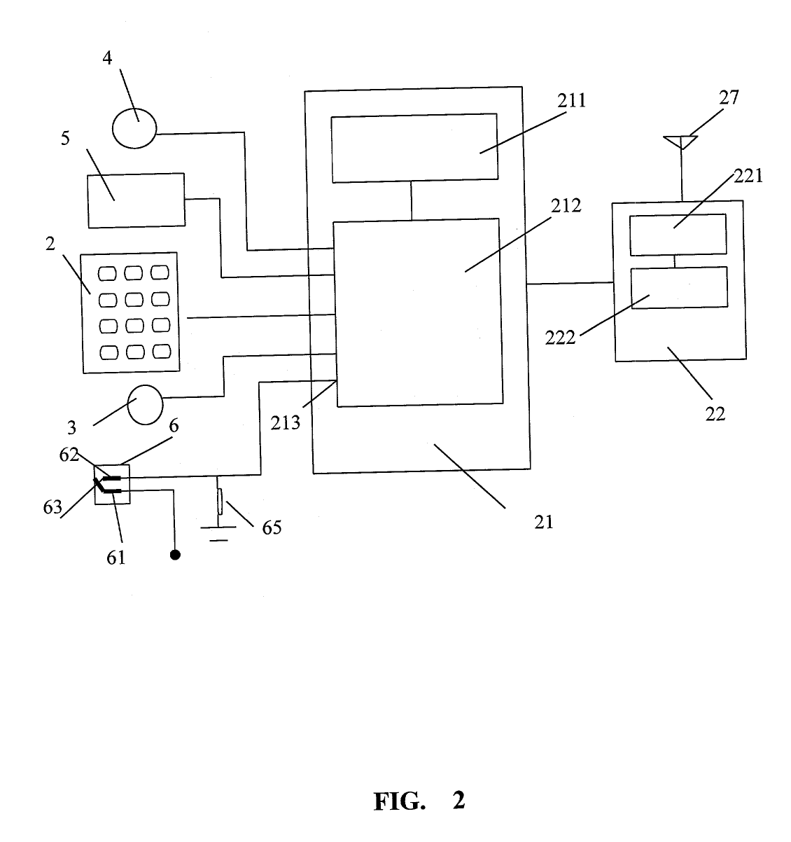

An electricity saving device for a user interface terminal device of a cellular phone according to the present invention is used on a cellular phone with two devices. One of two devices is a net communicator and another is a user interface terminal device. First, please refer to FIG. 1 that shows a circuit block diagram for a net communicator of a cellular phone. The figure shows a circuit block diagram of a net communicator of a cellular phone. The net communicator comprises a base frequency module 11, radio frequency module 12, and bluetooth module 13. Signals are transmitted to a base station from the radio frequency module 12 through an antenna 14 connected with it. The base module 11 comprises a memory 111 and CPU 112, here; the base frequency module 11 is a handling and relay unit for signals, which is responsible for inputting and outputting the signals and handling them. The bluetooth module 13 comprises a base frequency unit 132, radio frequency unit 131 and an antenna 15 disposed outside it, the bluetooth module 13 is a unit that is used to communicate with the bluetooth device of the bluetooth device of the user interface terminal device. Next, please refer to FIG. 2, which is a circuit block diagram of a user interface terminal device of a cellular phone. The user interface of the cellular phone mainly comprises a bluetooth module 22, base frequency module 21, speaker 4, display 5, keyboard 2, microphone 3 and etc. The bluetooth module 22 comprises a base frequency unit 222 and radio frequency unit 221 and antenna 27 disposed outside it, which is used for communicating with the bluetooth module 22 of the net communicator. The base frequency module 21 is also a handling and relay unit for signals, responsible for inputting and outputting the signals and handling them. Here, a speaker 23 is responsible for voice output, and display 24 displays message. A keyboard 25 used in the present invention is a retractable keyboard which is responsible for accepting the user's key-in input, and a microphone 26 is responsible for accepting the user's voice input. From the figure, it also shows that a contact switch 60 is installed on the user interface terminal device according to the present invention.

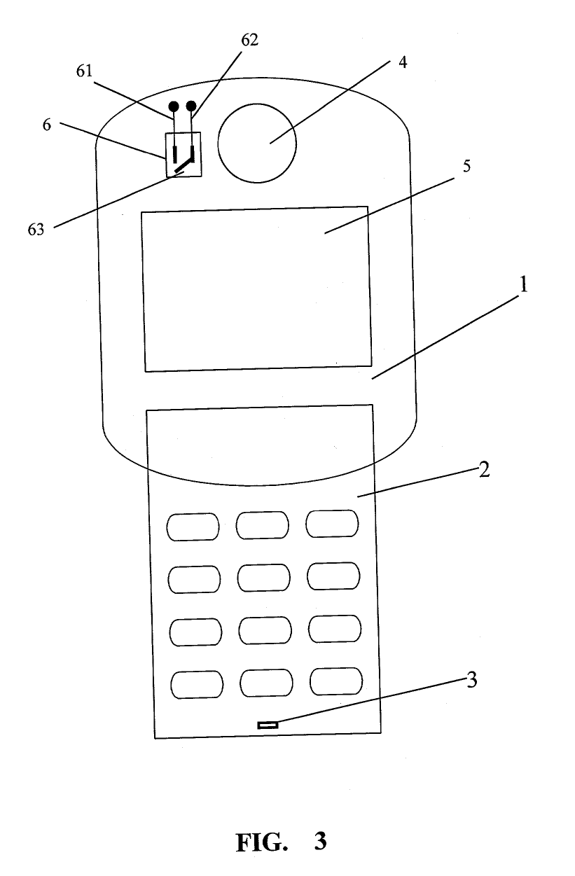

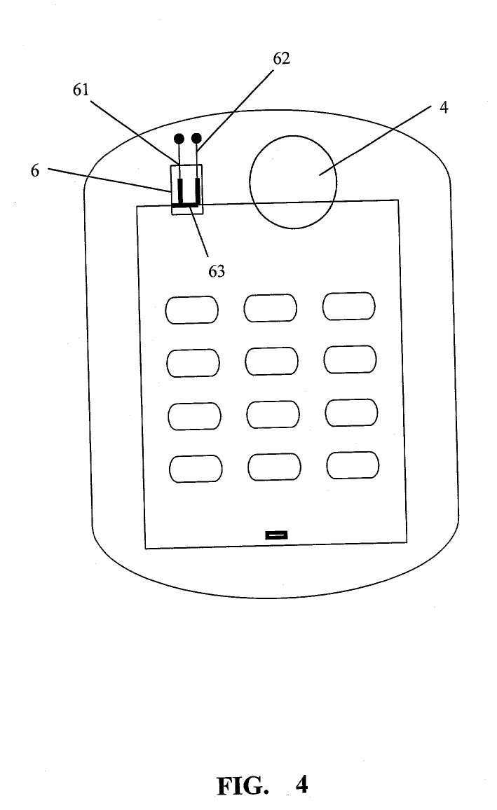

Please refer to FIG. 3 and 4, which show a cellular phone. The cellular phone 1 mainly comprises a retractable keyboard 2, microphone 3, speaker 4, display 5 and contact switch 6. The retractable keyboard 2 is used for inputting commands through the keys thereon. The microphone 3 is used for speaking. The speaker 4 is used for answering. Also the display 5 is used for displaying messages. The retractable keyboard 2 activates (touches or is separated from) the contact switch 6 in order to answer and terminate a phone call. The contact switch 6 comprises two terminals 61 and 62, one of the terminals 61 and 62 is connected to a high voltage signal and another is connected to a CPU 212. Furthermore, an elastic plate 63 is disposed between the two terminals; the elastic plate 63 is fixed at one of the two terminals, and free to the other terminal. The topside of the keyboard presses the elastic plate 63 to contact the other terminal to form a conduction state between the two terminals when the keyboard 2 is retracted back to the cellular phone 1, and the elastic plate 63 is separated from the other terminal when the keyboard 2 is drawn out from the cellular phone 1. On the occasions of the contact and separation, the voltage signal is changed.

Please refer to FIG. 2 again. The CPU 212 is connected to the contact switch 6 at a control signal input port 213; a ground resistance 65 is connected between them. It can clearly be seen that the CPU 212 handles the changed voltage signal of the contact switch 6.

The contact switch 6 disposed on the user interface terminal device is touched when the retractable keyboard 2 in the user interface terminal device is pressed back. A voltage signal is generated and delivered into the CPU 212 of the user interface terminal device after the contact switch 6 is touched, then the CPU will command the bluetooth module 22 of the user interface terminal device to enter into a park mode in order to save electricity.

When the user interface terminal device is in the park mode and the keyboard 2 is drawn out, the keyboard will leave the contact switch 6 and generate another voltage signal to the CPU 212 of the user interface terminal device, then the CPU will command the bluetooth module to return to a normal mode.

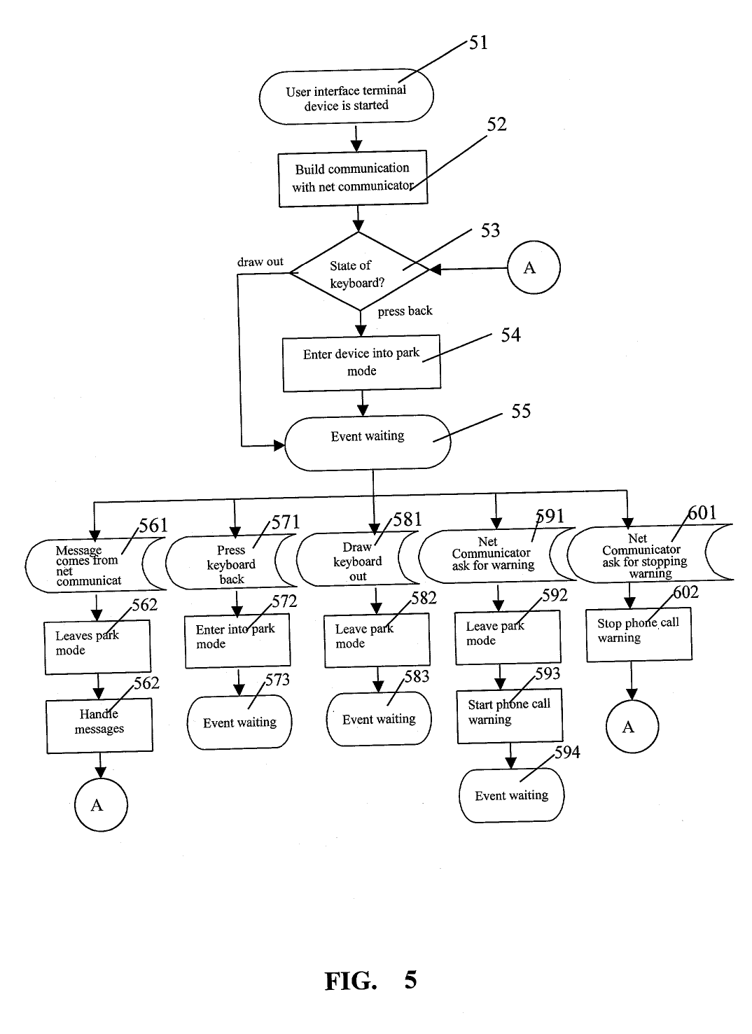

Finally, please refer to FIG. 5, which shows an operation flow chart for a user interface terminal device to control a bluetooth module to enter into a park mode. First, the user interface terminal device is started (step 51). Next, build a communication between the device and the net communicator (step 52), then, check the state of the keyboard (step 53); if the keyboard is drawn out, go to an event waiting (step 55), otherwise, if the keyboard is pressed back, enter the device into a park mode (step 54), then go to the event waiting (step 55). After that, there are five routes to be followed: first, a message comes from the net communicator (step 561), then let the bluetooth module leave the park mode (step 562) to handle the message (step 562), finally, go back to step 53 to check the state of the keyboard. Second, a user presses back the keyboard (step 571), enter the bluetooth module into the park mode (step 572), and then go to the event waiting state (step 573). Third, if the keyboard is in a pressing-back state, the user draws it out (step 581), the bluetooth module leaves the park mode (step 582), and then enter into the event waiting state (step 583). Fourth, the net communicator asks for a phone call warning (step 591), the bluetooth module leaves the park mode immediately (step 592), the CPU of the device starts the incoming phone call warning (step 593), such as a bell ringing or vibration, and then enter into the event waiting state (step 594). Fifth, during the warning period, the net communicator asks for stopping the incoming phone call warning (step 601), the CPU of the device stops the incoming phone call warning (step 602), and then check the state of the keyboard (step 53).

The device according to the present invention is used to leave a park mode by drawing a retractable keyboard out and to enter into a park mode by pressing a retractable keyboard in, devices having same structures and purposes are not found till now. Besides, an effect of electricity saving can be achieved easily by means of the device according to the present invention.

It is noted that an electricity saving device for a user interface terminal device of a cellular phone described above are the preferred embodiments of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. An electricity saving device for a user interface terminal device of a cellular telephone, mainly comprising a retractable keyboard and contact switch, wherein said contact switch is mainly disposed at a route for drawing out and pressing back a retractable keyboard of a cellular telephone; said contact switch being activated (untouched) to cause a bluetooth module to enter into a park mode when said keyboard of said cellular telephone is drawn out, said contact switch being activated (touched) to cause said bluetooth module to recover back to a normal mode when said drawn-out keyboard is pressed back in the middle of a telephone communication.

2. The electricity saving device of claim 1, wherein a voltage signal is changed after said contact switch is activated.

3. The electricity saving device of claim 2, wherein said voltage signal is sent into a CPU of said user interface terminal device.

4. The electricity saving device of claim 3, wherein a net communicator commands said bluetooth module of said user interface terminal device to recover back to said normal mode if a user message is received by said cellular telephone when said bluetooth module is in said park mode.

5. The electricity saving device of claim 3, wherein said bluetooth module is entered into said park mode after said CPU receives said voltage signal when said keyboard is pressed back and said contact switch is activated (touched).

6. The electricity saving device of claim 1, 4 or 5, wherein said contact switch is a keyboard type contact switch, one of two terminals of said switch is connected to a high voltage signal source and another is connected to said CPU.

7. The electricity saving device of claim 6, wherein an elastic plate that is used for disconnecting and conducting electricity is further disposed at said contact switch, only one end of said elastic plate is fixed to and contacts with one of said two terminals of said two terminals of said switch.

8. The device according to claim 7, wherein another end of said elastic plate separates from another terminal and said voltage signal is changed when said keyboard is drawn out.

9. The device according to claim 7, wherein another end of said elastic plate touches another terminal and said voltage signal is changed when said keyboard is pressed back.

10. The device according to claim 1, said contact switch is installed at the end of said route.

11. A cellular phone structure, comprising two devices, one is a net communicator which is responsible for building a communication with a cellular phone base station and the other is a user interface terminal device which are responsible for outputting voice, displaying messages, accepting a keystroke input, and voice input, respectively.

12. The structure of claim 11, wherein said net communicator consists of a base frequency module, radio frequency module and bluetooth module.

13. The structure of claim 11, wherein said user interface terminal device consists of a bluetooth module, display, keyboard, speaker and microphone.

14. The structure of claim 11, 12 or 13, wherein said net communicator and user interface terminal device are maintained a communication through said bluetooth modules.
